(19) United States
(12) Patent Application Publication
(10) Pub. No.: US 2007/0275203 A1
(43) Pub. Date: Nov. 29, 2007

(54) Separating Layer Carrier

(76) Inventor: Peter Ludwig, Raubling (DE)

Correspondence Address: PERRET DOISE;A PROFESSIONAL LAW CORPORATION, P.O. DRAWER 3408, LAFAYETTE, LA, 70502-3408, US

(21) Appl. No.: 10/587,967

(22) PCT Filed: Feb. 1, 2005
(86) PCT No.: PCT/DE05/00149

§ 371 Date: Jul. 31, 2006

(30) Foreign Application Priority Data
Feb. 6, 2004 (DE) 20 2004 001 8020
Jul. 22, 2004 (DE) 10 2004 035 697.1

(51) Int. Cl. C09J 7/02

(52) U.S. Cl. 428/42.3

(57) ABSTRACT

The invention relates to a separating layer carrier suitable for supporting a self-adhesive material provided with a layer of adhesive (20). Said carrier comprises a relief structure (22) with raised sections that form essentially complementary channels in the layer of adhesive (20), through which air blocked by the adhesion can escape. The relief structure (22) is at least partially formed by an impression on the substrate (10).

The invention relates to a separating layer carrier comprising a laminar substrate and a separating layer applied thereon. The separating layer carrier is suitable for depositing a self-adhesive material provided with a layer of adhesive. Said carrier comprises a relief structure with raised sections forming substantially complementary channels in the layer of adhesive, through which air trapped during adhesion can escape.

Self-adhesive materials are well known in practice. They usually have a viewing side, which can be transparent, translucent, non-transparent (opaque), single colored or multi-colored and/or carry any type of information, and a layer of adhesive on the back side. Prior to the adhesion, the adhesive is covered with a separating layer carrier (release liner). To carry out the adhesion, the separating layer carrier is peeled off and the self-adhesive material with the layer of adhesive is fixed on the base surface to be bonded.

Especially in the case of large area, air impermeable self-adhesive materials, e.g. having a plastic film on or behind the viewing side, a problem is created in that air is trapped during the adhesion, forming bubbles and preventing an adhesive contact with the base surface over the entire surface area. The external appearance of flexible self-adhesive materials can be influenced by the air bubbles or undesirable holes and/or creases, which are generated in the attempt to straighten out the air bubbles.

To prevent air bubbles during the adhesion, it is known to provide the separating layer carrier (release liner) of a self-adhesive material with a relief structure comprising raised sections, which, subsequent to the peeling off of the separating layer carrier, leave behind channels, at least temporarily, through which the trapped air can escape.

For this purpose, in EP 0 951 518 B1 a separating layer carrier comprised of polyethylene coated paper and a silicone separating layer is embossed in an additional process step (see examples 43 to 49 in EP 0 951 518 B1).

It is the object of the invention to provide a less complex means of producing a separating layer carrier of the initially described type with a relief structure.

In the separating layer carrier achieving this object, the relief structure is provided, at least in part, by an imprint on the substrate.

In a preferred embodiment, the substrate comprises paper, in particular coated paper. The relief structure of the substrate is completely or partially provided by way of an imprint on the paper coating.

It is generally known that the printability of paper and its capacity to be siliconized is improved by means of coating. Also in this case, the prior art for printing relief structures is extensive, for example for embossed printing or for decorative purposes (e.g. wallpapers, release paper for producing artificial leather). The printing inks used are partly thermally swelling and partly highly viscous and rapidly UV-curing. This prior art does not yield much for the invention. On the one hand, the conventionally imprinted relief structures are very crude and, on the other hand, the printing inks used are, at most, only compatible to a limited extent with the separating layer carrier to be applied on the substrate. Special silicone systems are employed for the separating layer carrier, which can be thermal or radiation curing, are applied as emulsion or solution with different solvents or as solvent-free solid silicone and are only too easily inhibited in their separating action by foreign chemicals, especially in the sense of an undesirable reduced chemical curing and adhesion of the silicone (“smear”, “rub-off”, “peel-off”). Thermal influences and long term effects must thereby be taken into account. The realization of a relief structure imprinted on coated paper for the purpose of the present invention required extensive research for silicone compatible printing inks and suitable printing technologies.

In alternative preferred embodiments, the substrate comprises plastic coated paper, plastic film or plastic coated plastic film. The substrate can be dispersion coated, laminated or extrusion coated with the plastic coating. The relief structure is provided by way of an imprint on the plastic.

In a further embodiment, the substrate of the separating layer carrier, which is comprised of paper or plastic film, is printed with the separating layer in order to apply said separating layer on the substrate over the entire surface and with the inventive relief structure. The printing technology enables the separating layer to be structured accordingly. Printing material comprises modified silicone systems or printing inks modified with silicone.

Subsequent to all the above, on the one hand, the relief structure can be imprinted on the substrate of the separating layer carrier and the substrate homogeneously siliconized in the conventional manner and, on the other hand, a separating layer comprising the relief structure can be imprinted on a homogeneous substrate.

In a preferred embodiment, the relief structure of the separating layer carrier according to the invention comprises sections having a width of from 50 μm to 200 μm and a height of from 5 μm to 40 μm.

In a preferred embodiment, the relief structure is a regular polygonal structure comprising polygons having between four and eight corners, in particular rhombuses or regular hexagons.

In a preferred embodiment, the relief structure is an irregular polygonal structure comprising stochastically shaped and distributed, corner-joined polygons having between four and seven corners.

In a preferred embodiment, each one polygon covers an area of from 0.5 mm² to 3 mm².

The invention relates in equal measure to the previously mentioned separating layer carriers (release liners) and self-adhesive materials deposited therewith.

The invention will be explained in more detail hereinafter with reference to exemplary embodiments illustrated in the drawing, wherein:

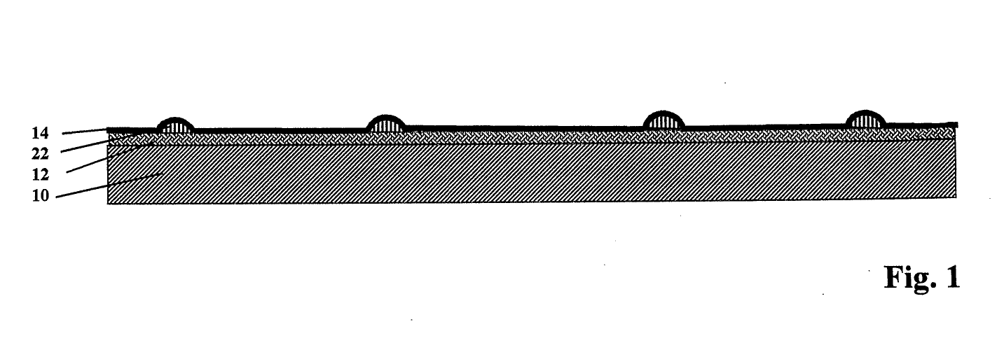

FIG. 1 is the schematic side view of a separating layer carrier comprising a substrate of coated paper, a raised relief structure imprinted thereon and a separating layer thereover;

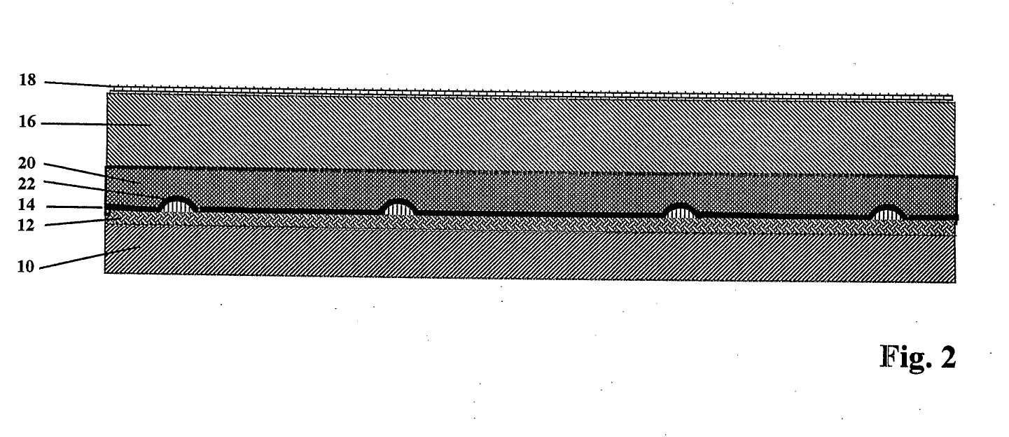

FIG. 2 is the schematic side view of a self-adhesive material comprising the separating layer carrier according to FIG. 1;

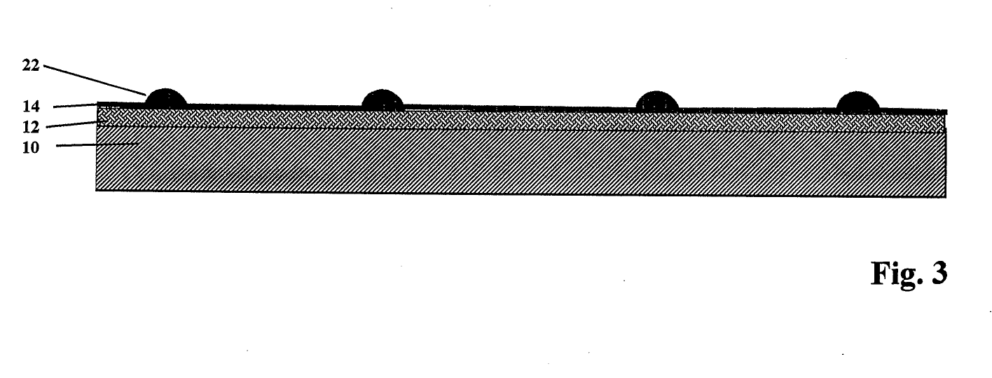

FIG. 3 is the schematic side view of a separating layer carrier comprising a substrate of coated paper and a separating layer imprinted thereon, which comprises a relief structure;

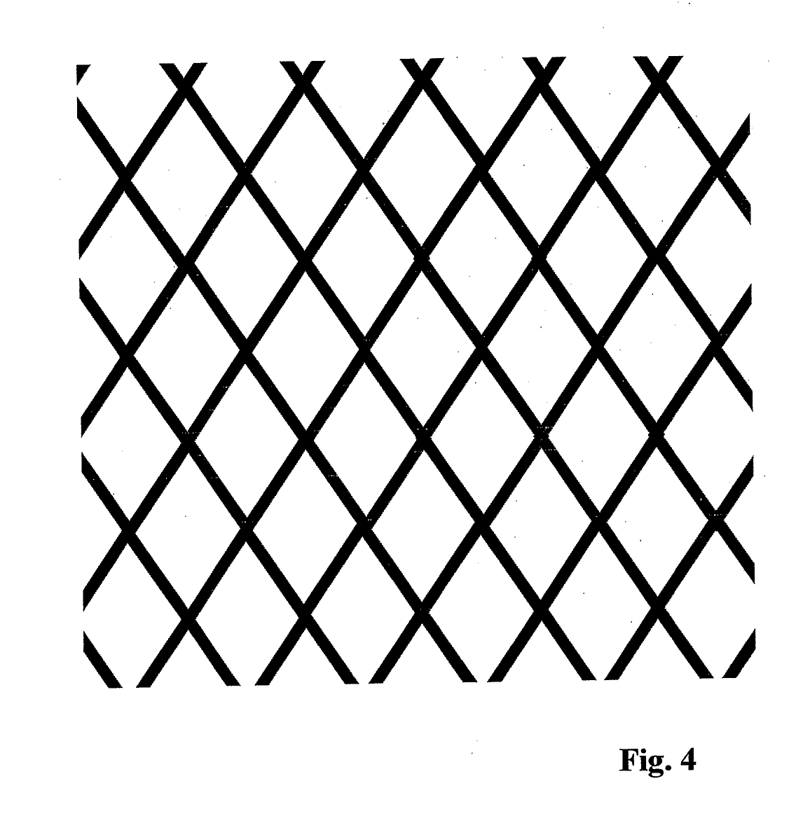

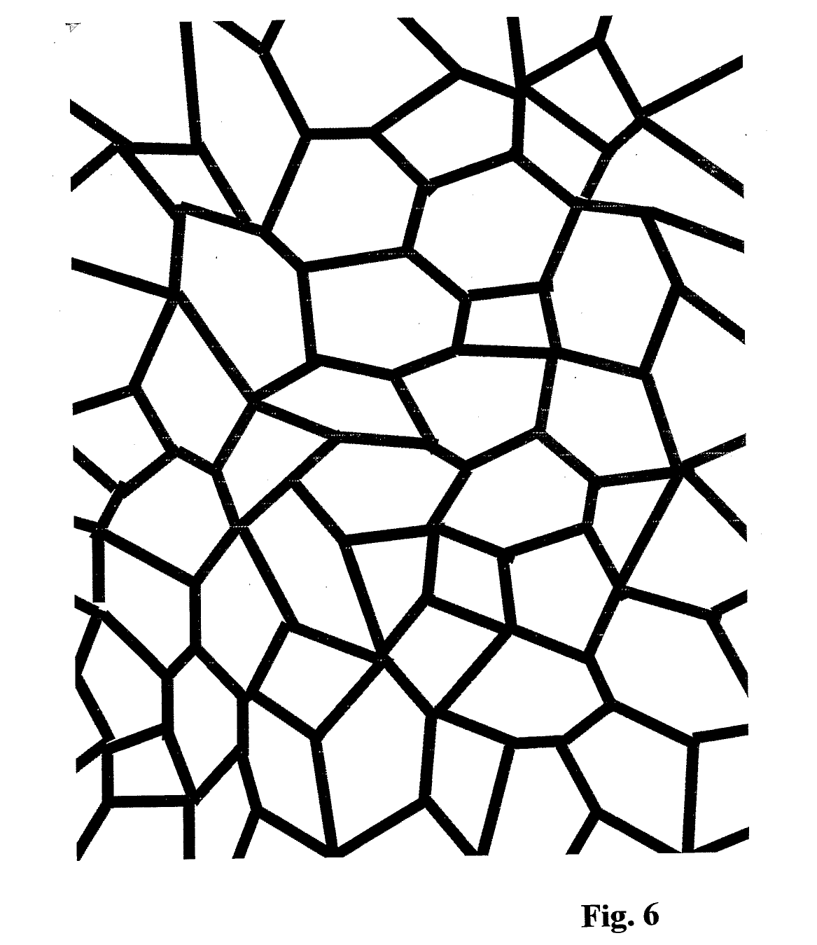

FIG. 4 to FIG. 6 are plan views of different relief structures, of which

FIG. 4 is regular rhomboidal,

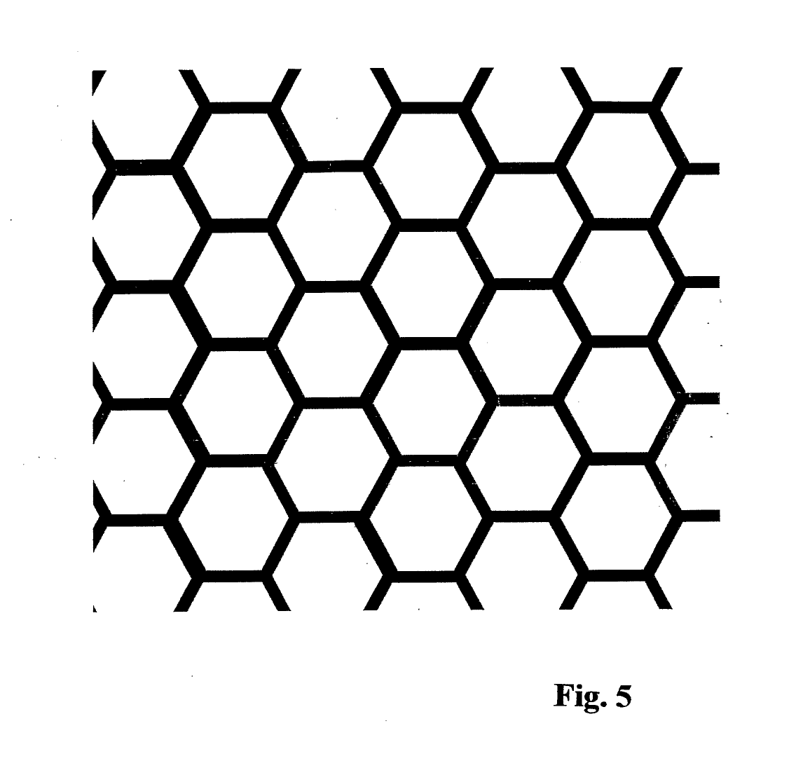

FIG. 5 is regular hexagonal, and

FIG. 5 is irregular polygonal comprising a stochastically varying shape and distribution of corner-joined polygons having between four and seven corners.

The separating layer carrier shown in FIG. 1 has a laminar substrate 10 of coated paper, on the planar coating 12 covering the entire surface of which there is imprinted a relief structure 22. Thereover is a separating layer 14 of silicone covering the entire surface.

FIG. 2 shows a self-adhesive material in which a print substrate 16 having an imprint 18 on the viewing side is coated with adhesive on the back side and the layer 20 of adhesive is deposited with the mentioned separating layer carrier.

In the same manner, FIG. 1 and FIG. 2 represent a separating layer carrier, which has a laminar substrate 10 of paper or plastic film. The substrate is dispersion coated, laminated or extrusion coated over the entire surface with a laminar plastic layer 12. A relief structure 22 is imprinted on the plastic layer 12.

The separating layer carrier shown in FIG. 3 has a laminar substrate 10 of coated paper, on the planar coating 12 covering the entire surface of which there is imprinted a separating layer 14 of silicone, which has a relief structure 22.

In the same manner, FIG. 3 represents a separating layer carrier, which has a laminar substrate 10 of paper or plastic film The substrate 10 is dispersion coated, laminated or extrusion coated over the entire surface with a planar plastic layer 12. A separating layer 14 of silicone comprising a relief structure 22 is imprinted on the plastic layer 12.

FIG. 4 to FIG. 6 show different relief structures.

### LIST OF REFERENCE SIGNS

10 Substrate
12 Coating or plastic coating
14 Separating layer
16 Print substrate
18 Imprint
20 Layer of adhesive
22 Relief structure

1. A separating layer carrier comprising a laminar substrate and a separating layer applied thereon, which is suitable for depositing a self-adhesive material provided with a layer of adhesive and comprises a relief structure with raised sections forming substantially complementary channels in the layer of adhesive, through which air trapped during adhesion can escape, characterized in that the relief structure is provided, at least in part, by an imprint on the substrate.

2. The separating layer carrier according to claim 1, wherein the substrate (10) comprises paper.

3. The separating layer carrier according to claim 2, wherein the substrate comprises coated paper.

4. The separating layer carrier according to claim 2, wherein the substrate comprises paper coated with plastic.

5. The separating layer carrier according to claim 1, wherein the substrate comprises plastic film.

6. The separating layer carrier according to claim 5, wherein the substrate comprises plastic film coated with plastic.

7. The separating layer carrier according to claim 1 wherein the separating layer is imprinted on the substrate with the relief structure covering the entire surface.

8. The separating layer carrier according to claim 1 wherein the relief structure is a regular polygonal structure comprising polygons having between four and eight corners, in particular rhombuses or regular hexagons.

9. The separating layer carrier according to claim 1 wherein the relief structure is an irregular polygonal structure comprising stochastically shaped and distributed corner-joined polygons having between four and seven corners.

10. The separating layer carrier according to claim 1 wherein the relief structure comprises sections having a width of from 50 um to 200 um and a height of from 5 um to 40 um.

11. The separating layer carrier according to claim 1 wherein each one polygon covers an area of from 0.5 mm² to 3 mm².

12. A self-adhesive material comprising a separating layer carrier according to claim 1.
